(19) United States
(12) Patent Application Publication
(10) Pub. No.: US 2026/0339004 A1
(43) Pub. Date: Oct. 29, 2026

(54) OPTICAL COMPONENT AND DISPLAY DEVICE

(71) Applicant: Shanghai Tianma Microelectronics Co., Ltd., Shanghai (CN)

(72) Inventors: Jinzhong ZHU, Shanghai (CN); Yang ZENG, Shanghai (CN)

(73) Assignee: Shanghai Tianma Microelectronics Co., Ltd., Shanghai (CN)

(21) Appl. No.: 19/262,075

(22) Filed: Jul. 7, 2025

(30) Foreign Application Priority Data
Apr. 25, 2025 (CN) 202510539639.5

(51) Int. Cl. G02B 5/136

(52) U.S. Cl. CPC G02B 5/136

(57) ABSTRACT

Embodiments of the present application provides an optical component and a display device. The optical component comprises: a first substrate, comprising a first edge extending along a first direction; a plurality of reflective columns provided in an array and located on a side of the first substrate, the reflective columns comprising at least first reflective columns and second reflective columns, an orthographic projection of the first reflective column on the first substrate is a first pattern, the first pattern comprises a first straight edge close to the first edge; an orthographic projection of the second reflective column on the first substrate is a second pattern, the second pattern comprises a second straight edge close to the first edge and intersecting with the first straight edge The embodiments of the present application can improve display uniformity.

### CROSS REFERENCE TO RELATED APPLICATION

The present application claims priority to Chinese Patent Application No. 202510539639.5 filed on Apr. 25, 2025, which is incorporated herein by reference in its entirety.

### TECHNICAL FIELD

The present application relates to the technical field of display, and in particular to an optical component and a display device.

### BACKGROUND

With the development of display technology, the display technology of suspended imaging is becoming more and more mature, making the application of suspended molding technology more and more extensive. For example, suspended imaging technology can be applied to the field of vehicle-mounted display.

In common suspension imaging technology, a reflector can be used to reflect the light provided by a light source multiple times, so that the light provided by the light source changes its path after multiple reflections to converge in the air and form a projected real image consistent with the display screen provided by the light source.

### SUMMARY

In a first aspect, embodiments of the present application provide an optical component, comprising: a first substrate which comprises a first edge extending along a first direction; a plurality of reflective columns provided in an array and located on a side of the first substrate, the reflective columns comprises at least a first reflective column and a second reflective column, an orthographic projection of the first reflective column on the first substrate is a first pattern, the first pattern comprises a first straight edge close to the first edge; an orthographic projection of the second reflective column on the first substrate is a second pattern, the second pattern comprises a second straight edge close to the first edge; the first straight edge intersects with the second straight edge.

In a second aspect, embodiments of the present application provide a display device, comprising the optical component described in the embodiments of the first aspect.

### BRIEF DESCRIPTION OF THE DRAWINGS

Other features, objects and advantages of the present application will become more apparent by reading the following detailed description of non-limiting embodiments with reference to the accompanying drawings, in which the same or similar reference numerals represent the same or similar features and the accompanying drawings are not drawn to scale.

FIG. 1 shows a schematic structural diagram of an optical component in the related art;

FIG. 2 shows a schematic structural diagram of another optical component in the related art;

FIG. 3 shows a schematic diagram showing a light path of an optical component in the related art;

FIG. 4 shows a schematic diagram showing a curve of incident angle and retroreflection brightness in the related art;

FIG. 5 shows a schematic three-dimensional structural diagram of an optical component provided in an embodiment of the present application;

FIG. 6 shows a schematic structural side view of FIG. 5;

FIG. 7 shows a schematic structural top view of FIG. 5;

FIG. 8 shows a schematic diagram showing a light path of FIG. 5;

FIG. 9 shows a schematic diagram showing a light path of FIG. 7;

FIG. 10 shows a schematic diagram showing a curve of incident angle and retroreflection brightness corresponding to FIG. 5;

FIG. 11 shows another schematic structural top view of an optical component provided in an embodiment of the present application;

FIG. 12 shows still another schematic structural top view of an optical component provided in an embodiment of the present application;

FIG. 13 shows still another schematic structural top view of an optical component provided in an embodiment of the present application;

FIG. 14 shows still another schematic structural top view of an optical component provided in an embodiment of the present application;

FIG. 15 shows still another schematic structural top view of an optical component provided in an embodiment of the present application;

FIG. 16 shows still another schematic structural top view of an optical component provided in an embodiment of the present application;

FIG. 17 shows still another schematic structural top view of an optical component provided in an embodiment of the present application;

FIG. 18 shows still another schematic structural top view of an optical component provided in an embodiment of the present application;

FIG. 19 shows still another schematic structural top view of an optical component provided in an embodiment of the present application;

FIG. 20 shows still another schematic structural top view of an optical component provided in an embodiment of the present application; and

FIG. 21 shows a schematic structural diagram of a display device provided in an embodiment of the present application.

### DETAILED DESCRIPTION

The features and exemplary embodiments of various aspects of the present application will be described in detail below. In order to make the purpose, technical solutions and advantages of the present application clearer, the present application will be further described in detail below in conjunction with the accompanying drawings and specific embodiments. It should be understood that the specific embodiments described herein are only configured to explain the present application and are not configured to limit the present application. For those skilled in the art, the present application can be implemented without the need for some of these specific details. The following description of the embodiments is only to provide a better understanding of the present application by illustrating the examples of the present application.

It should be noted that, in this article, relational terms such as first and second, etc. are only used to distinguish one entity or operation from another entity or operation, and do not necessarily require or imply any such actual relationship or order between these entities or operations. Moreover, the terms “include”, “comprise” or any other variants thereof are intended to cover non-exclusive inclusion, so that a process, method, article or device comprising a series of elements comprises not only those elements, but also other elements not explicitly listed, or also comprises elements inherent to such process, method, article or device. In the absence of further restrictions, the elements defined by the statement “include . . . ” do not exclude the presence of other identical elements in the process, method, article or device comprising the elements.

It should be understood that in the case that describing the structure of a component, in the case that a layer or an area is referred to as being “on” or “over” another layer or another area, it may mean that it is directly on the another layer or another area, or that other layers or areas are included between it and the other layer or another area. Moreover, if the component is turned over, the layer or the area will be “below” or “beneath” another layer or another area.

It should be understood that the term “and/or” used in this article is only a description of the association relationship of associated objects, indicating that there can be three relationships. For example, A and/or B can represent: A exists alone, A and B exist at the same time, and B exists alone. In addition, the character “/” in this article generally indicates that the associated objects before and after are in an “or” relationship.

It is obvious to those skilled in the art that various modifications and changes can be made in this application without departing from the spirit or scope of this application. Therefore, this application is intended to cover modifications and changes of this application that fall within the scope of the corresponding claims (technical solutions claimed for protection) and their equivalents. It should be noted that the implementation methods provided in the embodiments of this application can be combined with each other without contradiction.

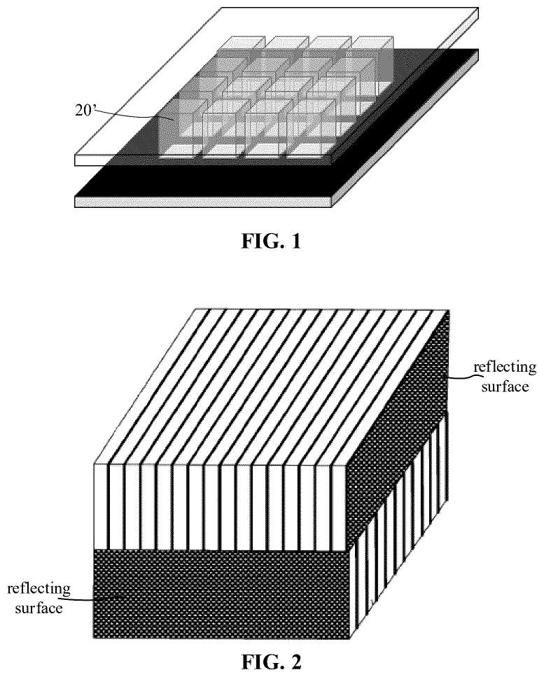

The optical components in the suspension imaging system of the related art adopt the structure shown in FIG. 1 or FIG. 2. As shown in FIG. 1, an array dihedral reflector can be formed by a plurality of reflective columns 20′ provided in an array as shown in FIG. 1, and the light provided by the light source is reflected multiple times to achieve suspension imaging. As shown in FIG. 2, a dihedral reflector is formed by two layers of mutually orthogonal optical waveguides, and the light provided by the light source is reflected multiple times to achieve suspension imaging.

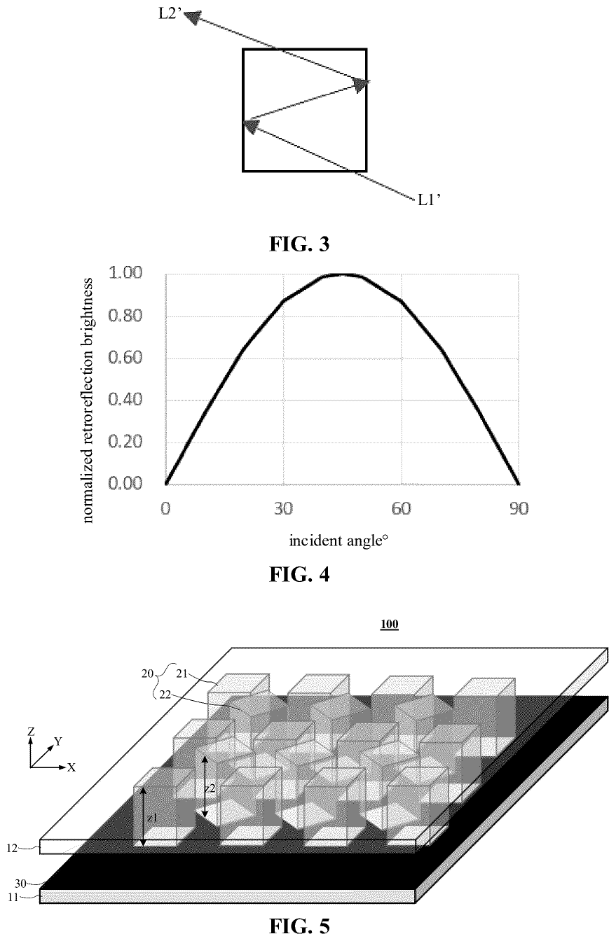

However, the inventors have found through research that the optical devices of the structures shown in FIGS. 1 and 2 have a problem of a small visible range of imaging. Please referring to FIG. 3, which simply illustrates a light path schematic diagram corresponding to FIGS. 1 and 2. In FIG. 3, after the incident light L1′ is incident on the dihedral reflector shown in FIG. 1 or 2, the light is reflected twice by the dihedral reflector to form an outgoing light L2′, and the outgoing light L2′ cannot be reflected back relative to the incident light L1′.

As shown in FIG. 4, for the optical device shown in FIG. 1 or FIG. 2, in the case that the incident angle of the incident light is 45°±20°, the normalized retroreflection brightness is larger, that is, the retroreflection effect is better, while for the incident light of a small angle or a large angle (such as 0-20° or 70-90°), the normalized retroreflection brightness is relatively small, that is, the retroreflection effect is poor, resulting in a small viewing angle, which leads to differences in imaging effects at different incident angles.

In order to solve the above technical problems, the embodiments of the present application provide an optical component and a display device. The embodiments of the optical component and the display device will be described below in conjunction with the accompanying drawings.

Please referring to FIGS. 5 to 7, the optical component 100 provided in the embodiments of the present application comprises a first substrate 11 and a plurality of reflective columns 20.

The first substrate 11 comprises a first edge 101 extending along a first direction X. The first substrate 11 is light-transmissive. The first substrate 11 may include a transparent material. For example, the first substrate 11 comprises but is not limited to glass or transparent plastic.

The plurality of reflective columns 20 are provided in an array in the first direction X and a second direction Y intersecting with the first direction X. The plurality of reflective columns 20 are provided on a side of the first substrate 11. The first substrate 11 comprises an upper surface and a lower surface opposite to each other, the reflective columns 20 are located on the upper surface of the first substrate 11 and extend in a third direction Z, which is perpendicular to the first direction X and the second direction Y.

An external light source is provided on a side of the lower surface of the first substrate 11, and the light provided by the external light source is incident on the lower surface of the first substrate 11, and then passes through the first substrate 11 to be incident on the reflective column 20. The reflective column 20 can reflect light. Specifically, the reflective column 20 comprises an upper surface, a lower surface, and a plurality of side surfaces. The upper surface and the lower surface of the reflective column 20 are light-transmissive, and the side surface of the reflective column 20 can reflect light. Specifically, the inner side of the side surface of the reflective column 20 can reflect light.

The reflective column 20 comprises at least first reflective columns 21 and second reflective columns 22. An orthographic projection of the first reflective column 21 on the first substrate is a first pattern 21a, and an orthographic projection of the second reflective column 22 on the first substrate is a second pattern 22b. The first pattern 21a comprises a first straight edge a1 close to the first edge 101, and the second pattern 22b comprises a second straight edge b2 close to the first edge 101 and intersect with the first straight edge a1.

The first straight edge a1 is a straight edge in the outer contour of the first pattern 21a, and the distance between the center of the first straight edge a1 and the first edge 101 is less than or equal to the distance between the center of any one of other sides in the first pattern 21a and the first edge 101. The second straight edge b2 is a straight edge in the outer contour of the second pattern 22b, and the distance between the center of the second straight edge b2 and the first edge 101 is less than or equal to the distance between the center of any one of other sides in the second pattern 22b and the first edge 101.

It can be understood that in the embodiments of the present application, the multiple reflective columns 20 are not provided along the same direction as shown in FIG. 1, but some of the reflective columns 20 are rotated by a certain angle, that is, the second reflective column 22 is rotated by a certain angle relative to the first reflective column 21, so as to compensate for the viewing angle of imaging of small-angle or large-angle incident light, thereby improving the uniformity of the overall display brightness.

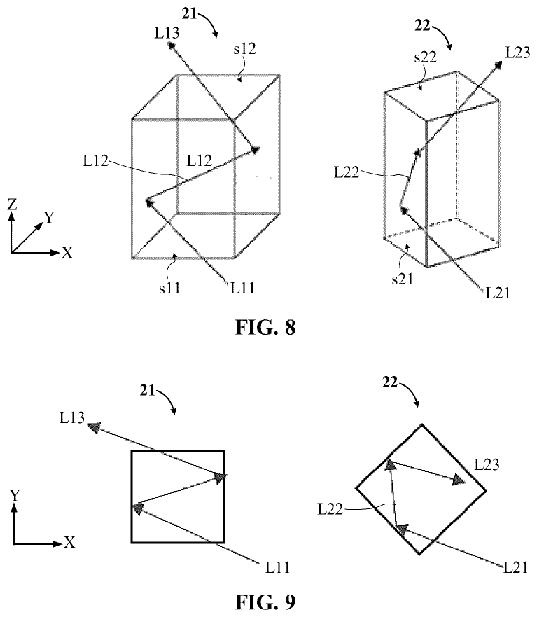

For example, taking an example that the first reflective column 21 and the second reflective column 22 are quadrangular prisms, please referring to FIGS. 8 and 9, the incident light L11 enters the first reflective column 21 from the lower surface s11 of the first reflective column 21, and the incident light L11 is reflected by a side surface of the first reflective column 21 to form a light L12, the light L12 is reflected by the other side surface of the first reflective column 21 to form an outgoing light L13, and the outgoing light L13 is emitted from the upper surface s12 of the first reflective column 21 and used to generate a desired suspended image. The outgoing light L13 does not form retroreflection relative to the incident light L11.

The second reflective column 22 is rotated by a certain angle relative to the first reflective column 21, so that for the incident light at the same angle, the transmission path of the light in the second reflective column 22 and the first reflective column 21 will change. Specifically, the incident light L21 enters the second reflective column 22 from the lower surface s21 of the second reflective column 22, and the incident light L21 is reflected by a side surface of the second reflective column 22 to form the light L22, and the light L22 is reflected by the other side surface of the second reflective column 22 to form the outgoing light L23, and the outgoing light L23 is emitted from the upper surface s22 of the second reflective column 22 and used to generate the desired suspended image. The outgoing light L23 can be reflected relative to the incident light L21.

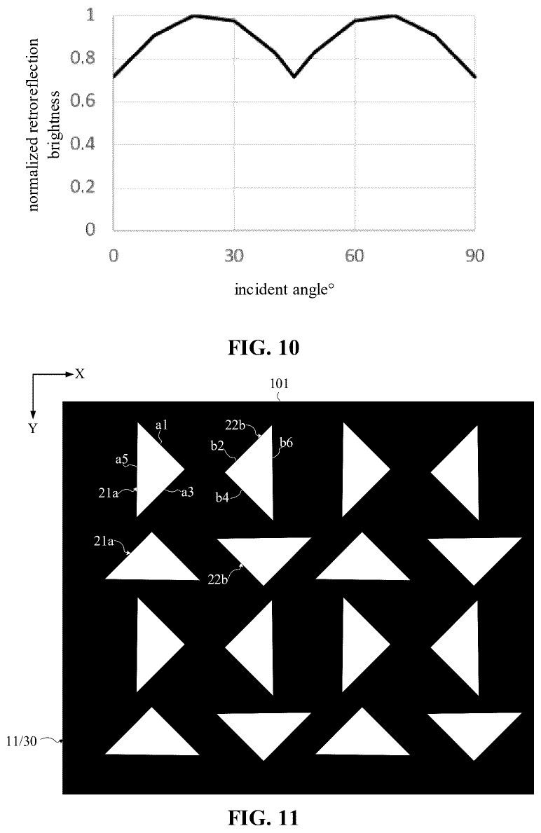

For example, taking an example that the first reflective column 21 and the second reflective column 22 each are a quadrangular prism, and the second reflective column 22 rotated 45° relative to the first reflective column 21, please referring to FIG. 10, since the second reflective column 22 rotates a certain angle relative to the first reflective column 21, this enables the outgoing light after the incident light is reflected by the second reflective column 22 to form retroreflection, thereby increasing the normalized retroreflection brightness corresponding to the incident light at a small angle or a large angle, increasing the display brightness of the suspended image corresponding to the incident light at a small angle or a large angle, increasing the overall viewing angle, and improving the uniformity of the overall display brightness. The normalized retroreflection brightness is the ratio of the retroreflection brightness to the overall maximum brightness, that is, the normalized retroreflection brightness is the ratio of the corresponding retroreflection angle brightness to the maximum brightness of all angles.

According to the optical component provided in the embodiments of the present application, the multiple reflective columns 20 are not provided in a same direction, but some of the reflective columns 20 are rotated by a certain angle, and the relative positions of the first reflective column 21 and the second reflective column 22 are different, that is, the second reflective column 22 is rotated by a certain angle relative to the first reflective column 21, which helps to make the incident light with a small or large angle reflected by the second reflective column 22 form a retroreflection relative to the incident light, thereby increasing the display brightness of the suspended image corresponding to the incident light with a small or large angle, increasing the overall viewing angle, and improving the uniformity of the overall display brightness.

In some embodiments, please referring to FIGS. 5 to 8, the first reflective column 21 comprises a first upper surface s12 and a first lower surface s11 parallel to the first upper surface s12. The second reflective column 22 comprises a second upper surface s22 and a second lower surface s21 parallel to the second upper surface s22.

Exemplarily, the first upper surface s12 of the first reflective column 21 and the second upper surface s22 of the second reflective column 22 are parallel, and the first lower surface s11 of the first reflective column 21 and the second lower surface s21 of the second reflective column 22 are parallel.

Exemplarily, the first reflective column 21 and the second reflective column 22 have the same height in the third direction Z.

The first pattern 21a comprises a third straight edge a3 perpendicular to the first straight edge a1, and the second pattern 22b comprises a fourth straight edge b4 perpendicular to the second straight edge b2.

It can be understood that the side surface to which the first straight edge a1 belongs and the side surface to which the third straight edge a3 belongs are two mutually perpendicular side surfaces of the first reflective column 21, and the side surface to which the first straight edge a1 belongs and the side surface to which the third straight edge a3 belongs constitute a mutually perpendicular dihedral reflector. Similarly, the side surface to which the second straight edge b2 belongs and the side surface to which the fourth straight edge b4 belongs are two mutually perpendicular side surfaces of the second reflective column 22, and the side surface to which the second straight edge b2 belongs and the side surface to which the fourth straight edge b4 belongs constitute a mutually perpendicular dihedral reflector.

The relative position relationship between the side surface to which the first straight edge a1 and the side surface to which the third straight edge a3 belong in the first reflective column 21 and the side surface to which the second straight edge b2 and the side surface to which the fourth straight edge b4 belong in the second reflective column 22 is different. For example, the side surface to which the second straight edge b2 in the second reflective column 22 is rotated by an angle α relative to the side surface to which the first straight edge a1 in the first reflective column 21 belongs, and the side surface to which the fourth straight edge b4 in the second reflective column 22 is rotated by an angle α relative to the side surface to which the third straight edge a3 in the first reflective column 21 belongs.

In this embodiment, the first reflection column 21 comprises two mutually perpendicular side surfaces, and the second reflection column 22 comprises two mutually perpendicular side surfaces, so that the first reflection column 21 and the second reflection column 22 both constitute mutually perpendicular dihedral reflectors, thereby realizing suspended imaging; in addition, the relative position relationship between the two mutually perpendicular side surfaces in the first reflection column 21 and the two mutually perpendicular side surfaces in the second reflection column 22 is different, which can make the light with the same incident angle have different angles of final outgoing light after being reflected by the first reflection column 21 and the second reflection column 22. For example, the light with a small or large angle of incident light can be reflected by the second reflection column 22 and the outgoing light can form retroreflection, thereby increasing the viewing angle and improving display uniformity.

In some embodiments, the first reflective column 21 is in the same shape as the second reflective column 22. In the present application, “the same shape” comprises: the shape of the orthographic projection of the first reflective column 21 on the first substrate 11 is the same as the shape of the orthographic projection of the second reflective column 22 on the first substrate 11. In other words, the shapes of the first pattern 21a and the second pattern 22b are the same.

In this embodiment, in the case that the shape of the first reflective column 21 is the same as the shape of the second reflective column 22, the light emitted from the entire optical component can be made more uniform, thereby further improving display uniformity.

Exemplarily, in the case that the shape of the first reflective column 21 is the same as the shape of the second reflective column 22, the size of the first reflective column 21 is the same as the size of the second reflective column 22. For example, the height of the first reflective column 21 is the same as the height of the second reflective column 22; the length of the first straight edge a1 of the first reflective column 21 is the same as the length of the second straight edge b2 of the second reflective column 22; the length of the third straight edge a3 of the first reflective column 21 is the same as the length of the fourth straight edge b4 of the second reflective column 22.

As an example, as shown in FIG. 5, the shape of the first reflective column 21 and the shape of the second reflective column 22 are both quadrangular prisms.

It is understandable that the first reflective column 21 comprises four side surfaces, and any two adjacent side surfaces are perpendicular to each other, so that the four side surfaces of the first reflective column 21 can reflect light, thereby avoiding limiting the angle of the outgoing light. Similarly, the second reflective column 22 comprises four side surfaces, and any two adjacent side surfaces are perpendicular to each other, so that the four side surfaces of the second reflective column 22 can also reflect light, thereby avoiding limiting the angle of the outgoing light.

In some embodiments, in the case that the first reflective column 21 is in the shape of a quadrangular prism, the lengths of the first straight edge a1 and the third straight edge a3 are the same, that is, the first upper surface s12 and the first lower surface s11 of the first reflective column 21 are square. In this way, after the first reflective column 21 is rotated 90°around its central axis, it can completely overlap with itself before the rotation, so that the light intensity after the light is more uniform.

In the case that the lengths of the first straight edge a1 and the third straight edge a3 are the same, please referring to FIGS. 5 and 7, the first pattern 21a is a square, the first pattern 21a comprises two diagonals, the lengths of the two diagonals of the first pattern 21a are the same, for example, the length of the diagonal of the first pattern 21a is x1, the height of the first reflective column 21 is z 1, the ratio of z1 to x1/2 is greater than or equal to 2, and the ratio of z1 to x1/2 is less than or equal to 5, where x1/2 represents half of x1.

For example, in the case that the second reflective column 22 is in the shape of a quadrangular prism, the second straight edge b2 and the fourth straight edge b4 have the same length, that is, the second upper surface s22 and the second lower surface s21 of the second reflective column 22 are square. In this way, after the second reflective column 22 is rotated 90° around its central axis, it can completely overlap with itself before the rotation, so that the light intensity after the light is more uniform.

In the case that the second straight edge b2 and the fourth straight edge b4 have the same length, please referring to FIGS. 5 and 7, the second pattern 22b is a square, the second pattern 22b comprises two diagonals, and the two diagonals of the second pattern 22b have the same length. For example, the diagonal length of the second pattern 22b is x2, the height of the second reflective column 22 is z2, the ratio of z2 to x2/2 is greater than or equal to 2, and the ratio of z2 to x2/2 is less than or equal to 5, where x2/2 represents half of x2.

The light needs travel a certain distance in the second reflective column 22. The inventors have found through extensive research that in the case that z2 and x2 satisfy the above relationship, the light emitted from the second reflective column 22 can form a specific retroreflection angle, thereby better achieving uniformity of display brightness.

In some embodiments, x1/2 is greater than or equal to 20 μm (micrometers), and x1/2 is less than or equal to 100 μm (micrometers); x2/2 is greater than or equal to 20 um (micrometers), and x2/2 is less than or equal to 100 μm (micrometers).

For example, x1=x2, z1=z2.

Exemplarily, taking an example that the first direction X is the row direction and the second direction Y is the column direction, as shown in FIG. 7, the optical component comprises multiple rows and columns of first reflective columns 21 and multiple rows and columns of second reflective columns 22. The spacing between adjacent first reflective columns 21 in the same row may be approximately x1/2+5 (μm), and the spacing between adjacent first reflective columns 21 in the same column may be approximately x1/2+5 (μm). The spacing between adjacent second reflective columns 22 in the same row may be approximately x1/2+5 (μm), and the spacing between adjacent second reflective columns 22 in the same column may be approximately x1/2+5 (μm).

The above examples introduce some examples in which the shape of the first reflective column 21 and the shape of the second reflective column 22 are the same and are both quadrangular prisms.

In other examples, in the case that the shape of the first reflective column 21 is the same as the shape of the second reflective column 22, the shape of the first reflective column 21 and the shape of the second reflective column 22 may also be other shapes besides a quadrangular prism.

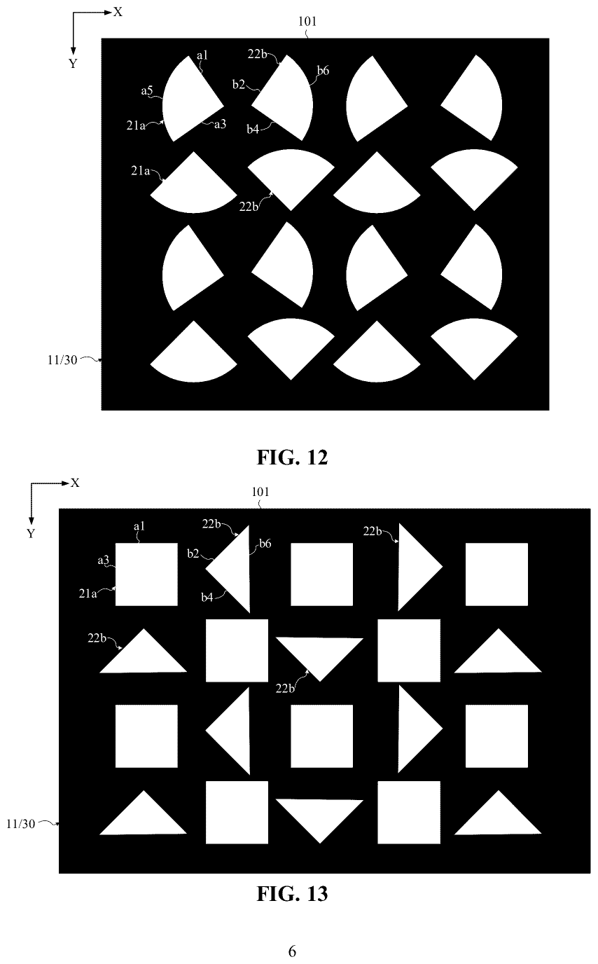

In some examples, as shown in FIG. 11 or 12, the first pattern 21a comprises a third straight edge a3 perpendicular to the first straight edge a1, the second pattern 22b comprises a fourth straight edge b4 perpendicular to the second straight edge b2, the shape of the first reflective column 21 is the same as the shape of the second reflective column 22, the first pattern 21a comprises a first connecting edge a5 connected to the first straight edge a1 and the third straight edge a3; the second pattern 22b comprises a second connecting edge b6 connected to the second straight edge b2 and the fourth straight edge b4.

In this example, the first upper surface s12 and the first lower surface s11 of the first reflective column 21 are triangles parallel to each other, and the second upper surface s22 and the second lower surface s21 of the second reflective column 22 are triangles parallel to each other. That is, the first reflective column 21 and the second reflective column 22 are both triangular prisms.

The side surface to which the first straight edge a1 belongs and the side surface to which the third straight edge a3 belongs are two mutually perpendicular side surfaces of the first reflective column 21, and the side surface to which the first straight edge a1 belongs and the side surface to which the third straight edge a3 belongs constitute a mutually perpendicular dihedral reflector, and even if the side surface to which the first connecting edge a5 belongs and the side surface to which the first straight edge a1 belongs and the side surface to which the third straight edge a3 belongs are not perpendicular, it will not affect the function of the first reflective column to achieve suspended imaging. Similarly, the side surface to which the second straight edge b2 belongs and the side surface to which the fourth straight edge b4 belongs are two mutually perpendicular side surfaces of the second reflective column 22, and the side surface to which the second straight edge b2 belongs and the side surface to which the fourth straight edge b4 belongs constitute a mutually perpendicular dihedral reflector, and even if the second connecting edge b6 and the side surface to which the second straight edge b2 belongs and the side surface to which the fourth straight edge b4 belongs are not perpendicular, it will not affect the function of the second reflective column to achieve suspended imaging.

As an example, as shown in FIG. 11, the first connecting edge a5 and the second connecting edge b6 are both straight line edges.

As another example, as shown in FIG. 12, the first connecting edge a5 and the second connecting edge b6 are both arc-shaped edges protruding outward.

The above examples introduce some examples in which the first straight edge a1 is perpendicular to the third straight edge a3, the second straight edge b2 is perpendicular to the fourth straight edge b4, and the shape of the first reflective column 21 is the same as the shape of the second reflective column 22.

In some embodiments, in the case that the first straight edge a1 is perpendicular to the third straight edge a3, the second straight edge b2 is perpendicular to the fourth straight edge b4, and the shape of the first reflective column 21 is the same as the shape of the second reflective column 22, the rotation angle of the second reflective column 22 relative to the first reflective column 21 is greater than 0° and less than 90°.

It is understandable that, in the case that the relative position relationship between the first reflective column 21 and the second reflective column 22 is the same, the first straight edge a1 is parallel to the second straight edge b2, and the third straight edge a3 is parallel to the fourth straight edge b4. In this embodiment, the relative position relationship between the first reflective column 21 and the second reflective column 22 is different, the second reflective column 22 is rotated by a certain angle relative to the first reflective column 21, the first straight edge a1 intersects with the second straight edge b2, and the third straight edge a3 intersects with the fourth straight edge b4. The angle between the first straight edge a1 and the second straight edge b2 is greater than 0° and less than 90°, and the angle between the third straight edge a3 and the fourth straight edge b4 is greater than 0° and less than 90°. The angle between the first straight edge a1 and the second straight edge b2 is equal to the angle between the third straight edge a3 and the fourth straight edge b4.

As an example, the rotation angle of the second reflective column 22 relative to the first reflective column 21 is 45°. The angle between the first straight edge a1 and the second straight edge b2 is 45°, and the angle between the third straight edge a3 and the fourth straight edge b4 is also 45°.

For example, the first reflective column 21 and the second reflective column 22 are both quadrangular prisms, and the upper and lower surfaces of the first reflective column 21 and the second reflective column 22 are both squares. After the first reflective column 21 rotates 90° around its central axis, it can completely overlap with itself before the rotation, and the same is true for the second reflective column, which means that rotating 90° is a rotation cycle. As shown in FIG. 4, in the case that the relative positions of the reflective columns are the same, the retroreflection brightness corresponding to the incident angles of 0° and 90° is the lowest, and the retroreflection brightness corresponding to the incident angle of 45° is the highest. In this embodiment, after the second reflective column 22 rotates 45° relative to the first reflective column 21, the retroreflection brightness corresponding to the incident angles of 0° and 90° in FIG. 10 is equivalent to the retroreflection brightness corresponding to the incident angle of 45° in FIG. 4, thereby enhancing the light intensity corresponding to the small-angle or large-angle incident light, so as to improve the display uniformity corresponding to different incident angles.

Of course, in other examples, the rotation angle of the second reflective column 22 relative to the first reflective column 21 may also be set as other values.

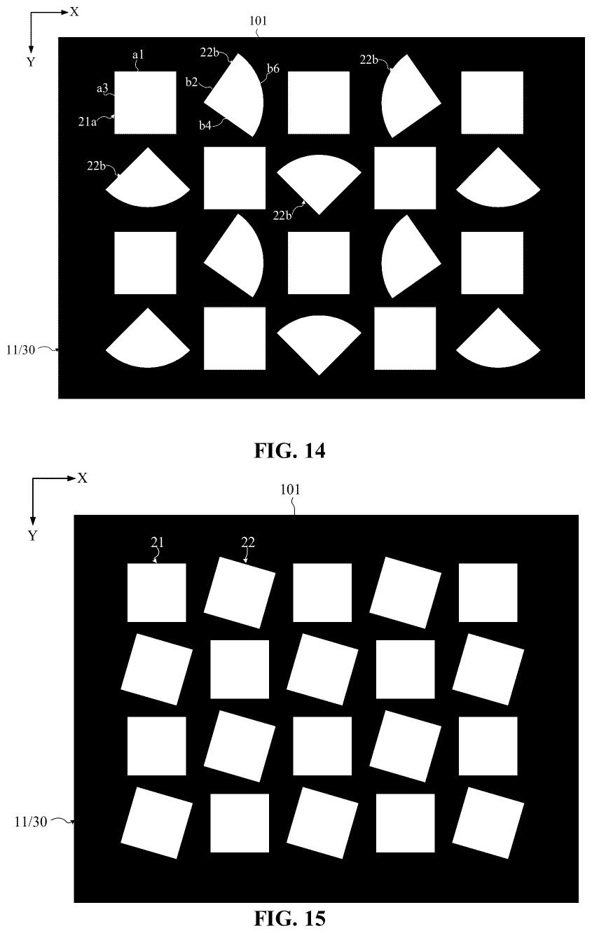

In other embodiments, as shown in FIG. 13 or 14, the first reflective column 21 is in a different shape from the second reflective column 22.

Here, “different shape” comprises: the shape of the orthographic projection of the first reflective column 21 on the first substrate 11 is different from the shape of the orthographic projection of the second reflective column 22 on the first substrate 11. In other words, the shapes of the first pattern 21a and the second pattern 22b are different.

In addition, the shape of the first reflective column 21 is different from that of the second reflective column 22, and the first straight edge a1 is perpendicular to the third straight edge a3, and the second straight edge b2 is perpendicular to the fourth straight edge b4.

In this embodiment, in the case that the shapes of the first reflective column 21 and the second reflective column 22 are different, the optical paths of the light in the different reflective columns can be adjusted more flexibly according to different requirements, thereby flexibly meeting different requirements.

In some embodiments, as shown in FIG. 13 or 14, the shape of the first reflective column 21 is different from that of the second reflective column 22, and the shape of the first reflective column 21 is a quadrangular prism, and the second pattern 22b comprises a second connecting edge b6 connected to the second straight edge b2 and the fourth straight edge b4.

Here, the first reflective column 21 is in the shape of a quadrangular prism, and the second reflective column 22 is in the shape of a triangular prism.

Exemplarily, in the case that the shape of the first reflective column 21 is a quadrangular column, the upper and lower surfaces of the first reflective column 21 are right-angled quadrilaterals, for example, the upper and lower surfaces of the first reflective column 21 are squares.

Exemplarily, as shown in FIG. 13, the first connecting edge a5 and the second connecting edge b6 are both straight edges. Alternatively, as shown in FIG. 14, the first connecting edge a5 and the second connecting edge b6 are both arc-shaped edges protruding outwards.

In some embodiments, the length of the first straight edge a1, the length of the second straight edge b2, the length of the third straight edge a3, the length of the fourth straight edge b4, and the length of the second connecting side b6 are equal.

Exemplarily, the height of the first reflective column 21 is the same as the height of the second reflective column 22. In this way, the area of the side surface to which the first straight edge a1 belongs, the area of the side surface to which the second straight edge b2 belongs, the area of the side surface to which the third straight edge a3 belongs, the area of the side surface to which the fourth straight edge b4 belongs, and the area of the side surface to which the second connecting edge b6 belongs are equal, so that the reflection areas of different side surfaces of the first reflective column 21 and different side surfaces of the second reflective column 22 are the same, which can improve the brightness uniformity at different viewing angles.

In some embodiments, taking FIGS. 5 and 7 as examples, the plurality of reflective columns 20 are provided at intervals in the first direction X and the second direction Y intersecting with the first direction X; center points of the plurality of reflective columns 20 in the same row in the first direction X are in the same first straight line L1; and/or, center points of the plurality of reflective columns 20 in the same column in the second direction Y are in the same second straight line L2.

In FIG. 7, the first reflective columns 21 and the second reflective columns 22 are located in different rows, and the first reflective columns 21 and the second reflective columns 22 are located in different columns. The center points of the plurality of first reflective columns 21 in the same row in the first direction X are located in one of the first straight lines L1, and the center points of the plurality of second reflective columns 22 in the same row in the first direction X are located in another first straight line L1. Additionally or alternatively, the center points of the plurality of first reflective columns 21 in the same column in the second direction Y are located in one of the second straight lines L2, and the center points of the plurality of second reflective columns 22 in the same column in the second direction Y are located in another second straight line L2.

Here, the first straight line L1 and the second straight line L2 are virtually defined position lines and do not represent actual routing lines.

In this embodiment, compared with the reflective column array shown in FIG. 1, the array arrangement of the multiple reflective columns is not changed, but some of the reflective columns are rotated along their central axes, so that the placement angle of the first reflective column 21 is different from the placement angle of the second reflective column 22.

Some examples of arrangement of the first reflective columns 21 and the second reflective columns 22 are introduced below.

As an example, as shown in FIG. 15, in the first direction X, the first reflective columns 21 and the second reflective columns 22 are provided alternately; additionally or alternatively, in the second direction Y intersecting with the first direction X, the first reflective columns 21 and the second reflective columns 22 are provided alternately.

In this example, both the first reflective columns 21 and the second reflective columns 22 are arranged in the same row. Additionally or alternatively, both the first reflective columns 21 and the second reflective columns 22 are arranged in the same column.

For example, the first reflective columns 21 and the second reflective columns 22 are provided alternately in the first direction X, and the first reflective columns 21 and the second reflective columns 22 are provided alternately in the second direction Y. The center points of the first reflective columns 21 and the second reflective columns 22 in the same row are located in the same first straight line, and the center points of the first reflective columns 21 and the second reflective columns 22 in the same column are located in the same second straight line.

For example, for incident light at the same angle, the retroreflective brightness after reflection by the second reflective column 22 is greater than the retroreflective brightness after reflection by the first reflective column 21. In this embodiment, the first reflective columns 21 and the second reflective columns 22 are alternately provided in the first direction and/or the second direction, which can make the overall distribution of the outgoing light more uniform, thereby improving display uniformity.

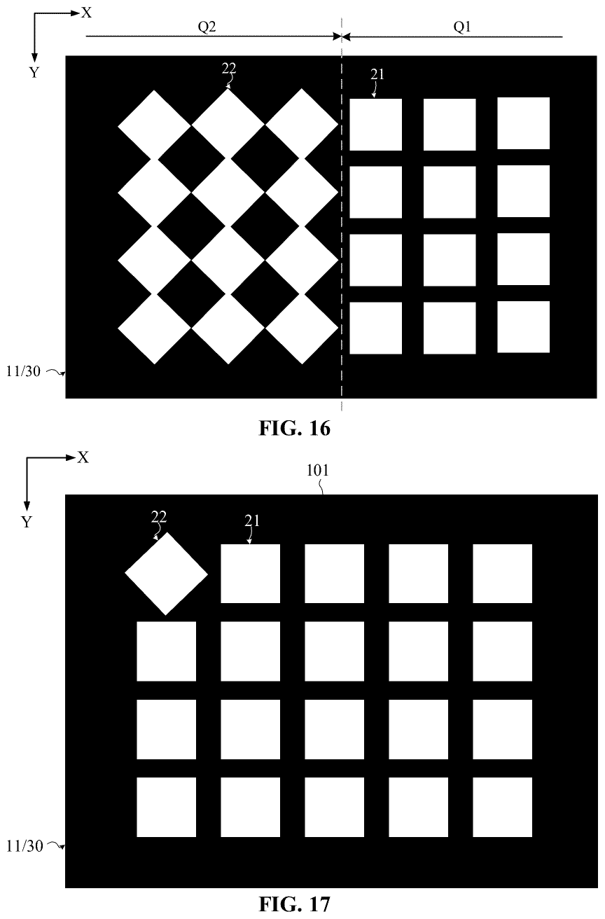

As another example, as shown in FIG. 16, a plurality of first reflective columns 21 are located in the first area Q1, a plurality of second reflective columns 22 are located in the second area Q2 adjacent to the first area Q1 in the first direction X.

Exemplarily, the first area Q1 comprises a plurality of first reflective columns 21 provided in an array in the first direction X and the second direction Y, and the second area Q2 comprises a plurality of second reflective columns 22 provided in an array in the first direction X and the second direction Y.

In this embodiment, the first reflective columns 21 and the second reflective columns 22 are distributed in different first areas Q1 and second areas Q2 provided in the first direction, so that the first area Q1 and the second area Q2 are used to display images with different brightness requirements, thereby flexibly meeting different display requirements.

Exemplarily, the number of the first reflective columns 21 in the first area Q1 and the number of the second reflective columns 22 in the second area Q2 may be equal. For example, the first reflective columns 21 and the second reflective columns 22 have the same shape and size, the spacing between adjacent first reflective columns 21 and the spacing between adjacent second reflective columns 22 are the same, and the first area Q1 and the second area Q2 have the same area.

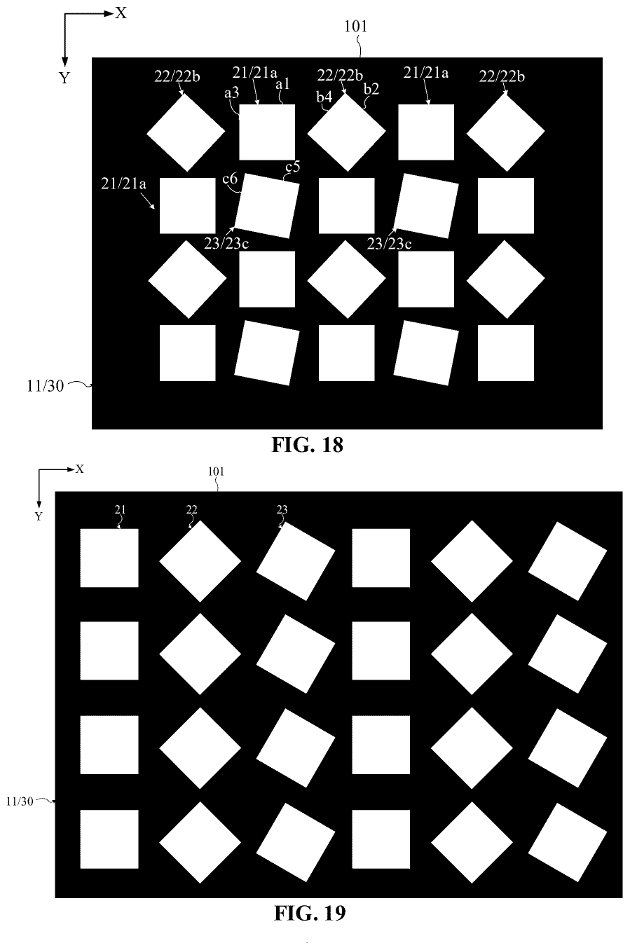

In some other embodiments, as shown in FIG. 17, the second reflective column 22 is located at an edge area of the optical component.

For example, the second reflective column 22 is provided at the edge area of the optical component and can be applied to a small viewing angle scene.

Exemplarily, in the case that the second reflective columns 22 are located at an edge area of the optical component, the number of the second reflective columns 22 may be less than the number of the first reflective columns 21.

Exemplarily, a plurality of second reflective columns 22 may be provided around the first reflective column 21.

In some other embodiments, as shown in FIG. 18, the reflective columns further comprises third reflective columns 23, an orthographic projection of each of the third reflective columns 23 on the first substrate 11 is a third pattern 23c, and the third pattern 23c comprises a fifth straight edge c5 close to the first edge 101 and intersecting with the first straight edge a1 and the second straight edge b2.

The fifth straight edge c5 is a straight edge in the outer contour of the third pattern 23c, and the distance between the center of the fifth straight edge c5 and the first edge 101 is less than or equal to the distance between the center of any one of other sides in the third pattern 23c and the first edge 101.

It is understandable that, in this embodiment, the second reflective column 22 is rotated at a certain angle relative to the first reflective column 21, the third reflective column 23 is rotated at a certain angle relative to the first reflective column 21, and the second reflective column 22 and the third reflective column 23 are rotated at different angles relative to the first reflective column 21. In this way, for incident light at the same angle, the transmission paths of the light in the first reflective column 21, the second reflective column 22, and the third reflective column 23 are all different, so that the angle of the outgoing light can be adjusted more flexibly, thereby better improving display uniformity.

The upper and lower surfaces of the third reflective column 23 are parallel to each other.

Exemplarily, the third pattern 23c further comprises a sixth straight edge c6 connected to and perpendicular to the fifth straight edge c5. The side surface to which the fifth straight edge c5 belongs and the side surface to which the sixth straight edge c6 belongs are two mutually perpendicular side surfaces of the third reflective column 23, and the side surface to which the fifth straight edge c5 belongs and the side surface to which the sixth straight edge c6 belongs constitute a mutually perpendicular dihedral reflector.

Exemplarily, the first reflective column 21, the second reflective column 22, and the third reflective column 23 may be the same in shape. For example, the first reflective column 21, the second reflective column 22, and the third reflective column 23 are all in the shape of a quadrangular prism. Alternatively, the first reflective column 21, the second reflective column 22, and the third reflective column 23 are all in the shape of a triangular prism.

Exemplarily, the first reflective column 21, the second reflective column 22, and the third reflective column 23 may be the same in shape, and the first reflective column 21, the second reflective column 22, and the third reflective column 23 may be the same in size.

Exemplarily, at least two of the first reflective column 21, the second reflective column 22, and the third reflective column 23 may have different shapes. For example, the first reflective column 21 is in the shape of a quadrangular prism, and the second reflective column 22 and the third reflective column 23 are both in the shape of a triangular prism. Alternatively, the first reflective column 21 is in the shape of a triangular prism, and the second reflective column 22 and the third reflective column 23 are both in the shape of a quadrangular prism.

In some embodiments, the rotation angle of the second reflective column 22 relative to the first reflective column 21 is α, and the rotation angle of the third reflective column 23 relative to the first reflective column 21 is β, where α≠β.

It is understandable that the relative positional relationship between the side surface to which the first straight edge a1 belongs and the side surface to which the third straight edge a3 belongs in the first reflective column 21, and the side surface to which the second straight edge b2 belongs and the side surface to which the fourth straight edge b4 belongs in the second reflective column 22 is different, and the relative positional relationship between the side surface to which the first straight edge a1 and the side surface to which the third straight edge a3 belong in the first reflective column 21 and the side surface to which the fifth straight edge c5 and the side surface to which the sixth straight edge c6 belong in the third reflective column 23 is different. For example, the side surface to which the second straight edge b2 in the second reflective column 22 belongs is rotated by an angle α relative to the side surface to which the first straight edge a1 in the first reflective column 21 belongs, and the side surface to which the fourth straight edge b4 in the second reflective column 22 belongs is also rotated by an angle α relative to the side surface to which the third straight edge a3 in the first reflective column 21 belongs. The side surface to which the fifth straight edge c5 in the third reflective column 23 belongs is rotated by an angle β relative to the side surface to which the first straight edge a1 in the first reflective column 21 belongs, and the side surface to which the sixth straight edge c6 in the third reflective column 23 belongs is also rotated by an angle β relative to the side surface to which the third straight edge a3 in the first reflective column 21 belongs.

In some embodiments, α=2*α.

Exemplarily, α is greater than 0° and less than 90°. For example, α=45°, β =22.5°.

Some examples of arrangement of the first reflective column 21, the second reflective column 22, and the third reflective column 23 are introduced below.

In some embodiments, as shown in FIG. 18, the first direction X is the row direction, the second direction is the column direction, and the optical component comprises a plurality of rows and columns of reflective columns. In the first direction X, the first reflective columns 21 and the second reflective columns 22 in some rows are provided alternately; the first reflective columns 21 and the third reflective columns 23 in other part of rows are provided alternately. In addition, in the second direction Y, the first reflective columns 21 and the second reflective columns 22 in some columns are provided alternately, and the first reflective columns 21 and the third reflective columns 23 in other part of columns are provided alternately.

For example, the first reflective columns 21 and the second reflective columns 22 in odd rows are provided alternately, and the first reflective columns 21 and the third reflective columns 23 in even rows are provided alternately. The first reflective columns 21 and the second reflective columns 22 in odd columns are provided alternately, and the first reflective columns 21 and the third reflective columns 23 in even columns are provided alternately.

In some other embodiments, as shown in FIG. 19, in the first direction X, a plurality of reflective columns are provided in the order of a first reflective column 21, a second reflective column 22, and a third reflective column 23.

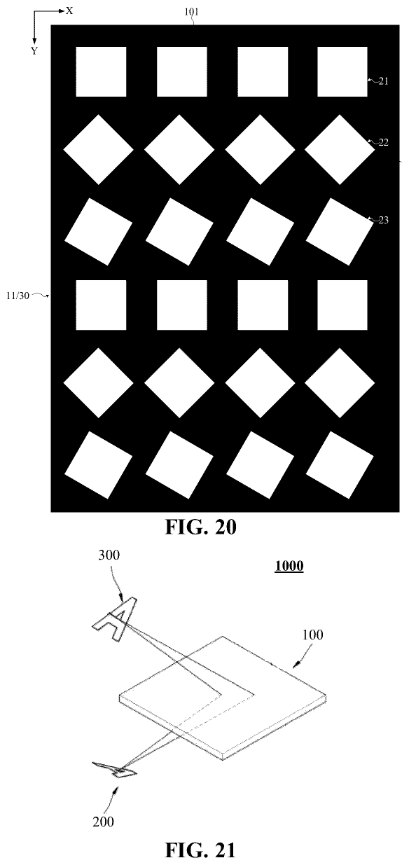

Alternatively, as shown in FIG. 20, in the second direction Y, a plurality of reflective columns are provided in the order of a first reflective column 21, a second reflective column 22, and a third reflective column 23.

In the examples shown in FIGS. 18 to 20, the first reflective columns 21, the second reflective columns 22 and the third reflective columns 23 are distributed relatively evenly as a whole, so that the outgoing light can be distributed relatively evenly as a whole, thereby improving display uniformity.

The above example only illustrates a part of arrangements of the first reflective column 21, the second reflective column 22, and the third reflective column 23. Of course, the first reflective column 21, the second reflective column 22, and the third reflective column 23 may also be provided in other arrangements, which is not limited in the present application.

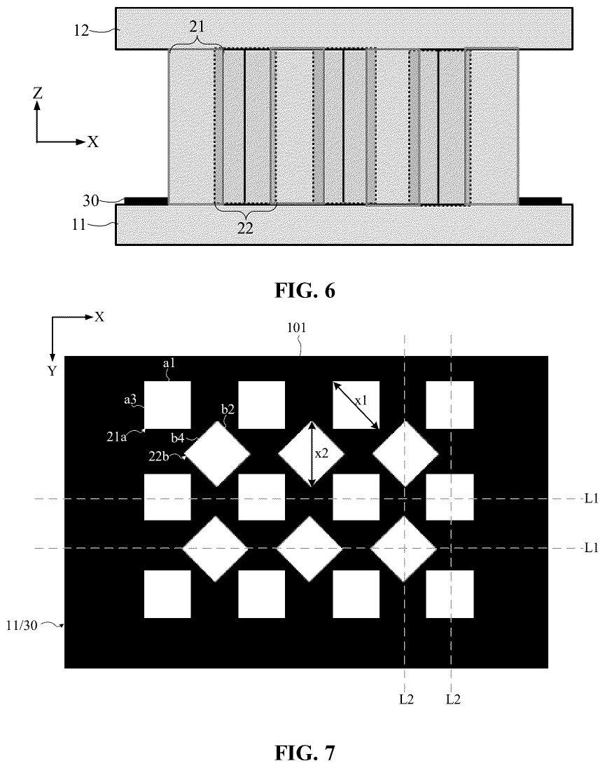

In some embodiments, as shown in FIGS. 5 and 6, the optical component further comprises a black matrix 30, the black matrix 30 and the reflective column 20 are located on a first side of the first substrate 11, the black matrix 30 comprises openings exposing the first side surface of the first substrate 11, and the reflective columns 20 are located in the openings.

The black matrix 30 can absorb light. For example, the black matrix 30 can absorb visible light. The light emitted by the external light source is emitted from the second side of the first substrate 11 toward the reflective column 20, and the black matrix 30 can absorb the light that does not enter the reflective column 20, so that the light can only be reflected by the reflective column 20, thereby preventing the light that does not enter the reflective column 20 from affecting the overall display effect.

Exemplarily, as shown in FIGS. 5 and 6, the optical component further comprises a second substrate 12, and the reflective column 20 is located between the second substrate 12 and the first substrate 11. The second substrate 12 is light-transmissive. The second substrate 12 may include a transparent material. For example, the second substrate 12 comprises but is not limited to glass or transparent plastic.

The present application further provides a display device, comprising the optical component provided by the present application. Please referring to FIG. 21, which is a schematic structural diagram of a display device provided by an embodiment of the present application. The display device 1000 provided in FIG. 21 comprises the optical component 100 provided by any of the above embodiments of the present application. The display device 1000 further comprises a light source 200 located on a side of the optical component 100, for example, the light source 200 is located on a side of the first substrate 11 of the optical component 100 away from the reflective columns 20.

The multiple light rays emitted by the light source 200 may be incident into the optical component 100, and after multiple reflections in the optical component 100, they may be emitted from the optical component. After the multiple light rays are reflected from the optical component 100, they may converge into a real image 300 (real image) in the air. In other words, the optical component 100 may be used to project the display screen formed by the light source 200 into the air on the other side of the display device, forming a real image identical to the display screen provided by the light source.

The light source 200 may be an electroluminescent device or a photoluminescent device. In the case that the light source 200 is an electroluminescent device, the electroluminescent device may be an organic light-emitting diode (OLED) light-emitting device or a quantum dot light emitting diode (QLED) light-emitting device. In the case that the light source 200 is a photoluminescent device, the photoluminescent device may be a quantum dot photoluminescent device.

The display device provided in the embodiments of the present application has the beneficial effects of the optical component provided in the embodiments of the present application. For details, the specific description of the optical component in the above embodiments should be referred to, which will not be repeated in this embodiment.

According to the embodiments described above in the present application, these embodiments do not describe all the details in detail, nor do they limit the present application to the specific embodiments described. Obviously, many modifications and changes can be made based on the above description. This specification selects and specifically describes these embodiments in order to better explain the principles and practical applications of the present application, so that those skilled in the art can make good use of the present application and the modifications based on the present application. The present application is limited only by the claims and their full scope and equivalents.

What is claimed is:

1. An optical component, comprising:
a first substrate comprising a first edge extending along a first direction;
a plurality of reflective columns provided in an array and located on a side of the first substrate, the plurality of reflective columns comprising at least a first reflective column and a second reflective column, wherein
an orthographic projection of the first reflective column on the first substrate is a first pattern comprising a first straight edge close to the first edge, and an orthographic projection of the second reflective column on the first substrate is a second pattern comprising a second straight edge close to the first edge and intersecting with the first straight edge.

2. The optical component according to claim 1, wherein the first reflective column comprises a first upper surface and a first lower surface parallel to the first upper surface;
the second reflective column comprises a second upper surface and a second lower surface parallel to the second upper surface; and
the first pattern comprises a third straight edge perpendicular to the first straight edge, and the second pattern comprises a fourth straight edge perpendicular to the second straight edge.

3. The optical component according to claim 2, wherein the first reflective column is in the same shape as the second reflective column;
the first reflective column and the second reflective column each are in the shape of a quadrangular prism.

4. The optical component according to claim 3, wherein the first pattern comprises a first connecting edge connected to the first straight edge and the third straight edge; and
the second pattern comprises a second connecting edge connected to the second straight edge and the fourth straight edge.

5. The optical component according to claim 4, wherein the first connecting edge and the second connecting edge each are a straight line; or,
the first connecting edge and the second connecting edge each are an arc-shaped edge protruding outward.

6. The optical component according to claim 2, wherein the first reflective column is in a different shape from the second reflective column.

7. The optical component according to claim 6, wherein the first reflective column is in the shape of a quadrangular prism, and the second pattern comprises a second connecting edge connected to the second straight edge and the fourth straight edge.

8. The optical component according to claim 7, wherein a length of the first straight edge, a length of the second straight edge, a length of the third straight edge, a length of the fourth straight edge and a length of the second connecting side are equal.

9. The optical component according to claim 3, wherein a length of the first straight edge is equal to a length of the third straight edge, a diagonal length of the first pattern is x1, a height of the first reflective column is z1, a ratio of z1 to x1/2 is greater than or equal to 2, and a ratio of z1 to x1/2 is less than or equal to 5.

10. The optical component according to claim 3, wherein a rotation angle of the second reflective column relative to the first reflective column is greater than 0° and less than 90°.

11. The optical component according to claim 10, wherein the rotation angle of the second reflective column relative to the first reflective column is 45°.

12. The optical component according to claim 1, wherein the plurality of reflective columns are provided at intervals in the first direction and the second direction intersecting with the first direction;
center points of the plurality of reflective columns arranged in a same row in the first direction are in a same first straight line; and/or,
center points of the plurality of reflective columns arranged in a same row in the second direction are in a same second straight line.

13. The optical component according to claim 1, wherein
in the first direction, the first reflective columns and the second reflective columns are arranged alternately; and/or,
in the second direction intersecting with the first direction, the first reflective columns and the second reflective columns are arranged alternately.

14. The optical component according to claim 1, wherein a plurality of the first reflective column are located in a first area, a plurality of the second reflective column are located in a second area adjacent to the first area in the first direction;
a number of the first reflective columns is equal to a number of the second reflective columns.

15. The optical component according to claim 1, wherein the plurality of reflective columns further comprise a third reflective column, an orthographic projection of the third reflective column on the first substrate is a third pattern comprising a fifth straight edge close to the first edge; and
the fifth straight edge intersects with the first straight edge, and the fifth straight edge intersects with the second straight edge.

16. The optical component according to claim 15, wherein in the first direction, the first reflective columns and the second reflective columns are provided alternately in some rows;
and the first reflective columns and the third reflective columns are provided alternately in another part of rows.

17. The optical component according to claim 15, wherein in the first direction, the plurality of reflective columns are provided in an order of the first reflective column, the second reflective column, and the third reflective column; or,
in the second direction intersecting with the first direction, the plurality of reflective columns are provided in the order of the first reflective column, the second reflective column, and the third reflective column.

18. The optical component according to claim 15, wherein a rotation angle of the second reflective column relative to the first reflective column is α, a rotation angle of the third reflective column relative to the first reflective column is β, where α≠β.

19. The optical component according to claim 1, further comprising a black matrix, wherein the black matrix and the plurality of reflective columns are located on a first side of the first substrate, the black matrix comprises openings exposing a first side surface of the first substrate, and the plurality of reflective columns are located in the openings.

20. A display device, comprising an optical component comprising:
a first substrate comprising a first edge extending along a first direction;
a plurality of reflective columns provided in an array and located on a side of the first substrate, the plurality of reflective columns comprising at least a first reflective column and a second reflective column, wherein
an orthographic projection of the first reflective column on the first substrate is a first pattern comprising a first straight edge close to the first edge, and an orthographic projection of the second reflective column on the first substrate is a second pattern comprising a second straight edge close to the first edge and intersecting with the first straight edge.
